(19) United States
(12) Patent Application Publication
(10) Pub. No.: US 2026/0270107 A1
(43) Pub. Date: Sep. 10, 2026

(54) DISTRIBUTED DYNAMIC POWER MANAGEMENT WITHOUT REAL TIME MANAGER

(71) Applicant: Microchip Technology Inc., Chandler, AZ (US)

(72) Inventors: Alon Ferentz, Petach Tikva (IL); Avi Tkuma, Bat-Yam (IL); Tamir Langer, Tel Aviv (IL); Nir Barniv, Herzliya (IL)

(73) Assignee: Microchip Technology Inc., Chandler, AZ (US)

(21) Appl. No.: 19/281,848

(22) Filed: Jul. 28, 2025

Related U.S. Application Data
(60) Provisional application No. 63/766,887, filed on Mar. 4, 2025.

(51) Int. Cl. H04L 12/40; H04L 12/10

(52) U.S. Cl. CPC H04L 12/40045; H04L 12/10

(57) ABSTRACT

A power over ethernet (POE) power sourcing and distributing system that measures the power consumptions of a first and second power sourcing equipment (PSE) devices, transmits the second power consumption from the second PSE device to the first PSE device, calculates by the first PSE device a total power consumption from the first and second power consumptions, and compares by the first PSE device the total power consumption to a power consumption budget and disconnects a port of the first PSE device according to a first port disconnect list when the total power consumption is greater than a predetermined power consumption threshold.

### PRIORITY STATEMENT

This application claims priority to U.S. Provisional Patent Application No. 63/766,887, filed March 04, 2025, the contents of which are hereby incorporated in their entirety for all purposes.

### TECHNICAL FIELD

Aspects related to a power budget management scheme in Power Over Ethernet (POE) systems, and in particular, to a power budget management scheme for multiple power sourcing equipment (PSE) devices being managed by a POE host, such as an ethernet switch.

### BACKGROUND

Twisted pair ethernet is a standardized networking technology that enables data communications over pairs of twisted wires. Often a home, office, or other building has four pair cables connecting various rooms, offices, workspaces, printer locations, and wireless access point locations to a centralized networking area. The centralized networking area may include one or more ethernet switches that provide ethernet networking connectivity to one end of the four pair cables. A user may then setup a computer in an office space with an ethernet cable between a wall jack and the computer thereby completing the ethernet connection between the computer and the ethernet switch.

POE technology has been developed to allow user POE devices, such as IP telephones, wireless LAN Access Points and other appliances, to receive power as well as data over existing network cabling, without needing to modify the existing Ethernet infrastructure. Electrical systems that distribute power over ethernet cabling are described and defined by IEEE Standard 802.3-2005, Clause 33.

In general, a POE network is formed by a Power Sourcing Equipment (PSE) supplying power and a Powered Device (PD) receiving and utilizing the power. A PSE, which can be an endspan or a midspan network device, injects power onto the designated twisted wire pair of the Ethernet cables forming the local area network. At the other end of the cables, the power is used to run the Powered Devices so that no additional source of power needs to be provided to the Powered Devices. The Power Sourcing Equipment devices thereby provide on the same Ethernet cable both power and data signals to the Powered Devices.

POE switches include a power supply that can often supply an amount of power that is less than the amount per-device power limited under the standard if all ports are enabled. Some POE devices like office phones consume no more than 12W and often consume less. For example, if a phone is idle, it may draw 5W whereas when the speaker phone is in use at full volume it may draw 12W. Similarly, if a wireless access point is idle, it may draw as little as 5W and if a dozen people arrive in the conference room for a meeting with laptops and phones the wireless access point may draw 100W.

A POE manager monitors the power supply capabilities and POE port demands and may disconnect POE ports if excess power is demanded. Existing POE management approaches require either a high-speed real-time management bus or both a lower speed real-time management bus and a second fast disconnect communications bus. Further, existing POE management approaches use a real-time manager component to allow a timely response to an overpower event.

A power supply may operate safely above its specified output capacity for a short period of time. For example, some power supplies may be able to safely operate at 105% capacity for a few seconds without damage. Some power supplies may be able to safely operate at 110% capacity for a fraction of a second. Some power supplies may be damaged by operating at more than 120% power capacity for more than a second.

There is a need for a POE management system that monitors power usage and power supply and quickly enables powered devices to operate within power supply capacity.

### SUMMARY

According to an aspect, there is provided a method comprising: measuring by a first power sourcing equipment (PSE) device a first power consumption of the first PSE device; receiving a second power consumption from a second PSE device by the first PSE device; calculating by the first PSE device a total power consumption from the first and second power consumptions; and comparing by the first PSE device the total power consumption to a power consumption budget and disconnecting a port of the first PSE device according to a first port disconnect list when the total power consumption is greater than a predetermined power consumption threshold.

Aspects as in the preceding paragraph provide a method, comprising: transmitting the first power consumption from the first PSE device to the second PSE device; calculating by the second PSE device the total power consumption from the first and second power consumptions; and comparing by the second PSE device the total power consumption to the power consumption budget and disconnecting a port of the second PSE device according to the first port disconnect list when the total power consumption is greater than the predetermined power consumption threshold.

Aspects as in one of the two preceding paragraphs provide a method, comprising transmitting the first port disconnect list and the predetermined power consumption threshold from a power over ethernet (POE) host to the first PSE device.

Aspects as in one of the three preceding paragraphs provide a method, comprising: transmitting the first port disconnect list and the predetermined power consumption threshold from a power over ethernet (POE) host to the first PSE device; and transmitting the first port disconnect list and the predetermined power consumption threshold from the POE host to the second PSE device.

Aspects as in one of the four preceding paragraphs provide a method, wherein transmitting from the POE host to the first PSE device comprises periodically transmitting with a period greater than one second.

Aspects as in one of the five preceding paragraphs provide a method, wherein transmitting from the second PSE device to the first PSE device comprises transmitting in real time.

Aspects as in one of the six preceding paragraphs provide a method, wherein the predetermined power consumption threshold comprises a power consumption budget and a predetermined percentage.

Aspects as in one of the seven preceding paragraphs provide a method, comprising disconnecting a port of the first PSE device according to the second port disconnect list when the total power consumption is greater than the predetermined power consumption threshold.

Aspects as in one of the eight preceding paragraphs provide a method, comprising repeating within twenty milliseconds: the measuring by a first PSE device a first power consumption of the first PSE device; the measuring by a second PSE device a second power consumption of the second PSE device; the transmitting the second power consumption from the second PSE device to the first PSE device; the calculating by the first PSE device a total power consumption from the first and second power consumptions; and the comparing by the first PSE device the total power consumption to a power consumption budget and disconnecting a port of the first PSE device according to a first port disconnect list when the total power consumption is greater than a predetermined power consumption threshold.

According to aspects, there is provided a power over ethernet (POE) system comprising: a first power sourcing equipment (PSE) device having a first PSE device circuit to measure a first power consumption of the first PSE device and a first PSE device receiver to receive a second power consumption; a second PSE device having a second PSE device circuit to measure the second power consumption, wherein the second power consumption is of the second PSE device, and a second PSE device transmitter to transmit the second power consumption to the first PSE device; wherein the first PSE device circuit is to: calculate a total power consumption from the first and second power consumptions; compare the total power consumption to a predetermined power consumption threshold; and disconnect a port of the first PSE device according to a first port disconnect list when the total power consumption is greater than the predetermined power consumption threshold.

Aspects as in the preceding paragraph provide a system, wherein: the first PSE device has a first PSE device transmitter to transmit the first power consumption to the second PSE device; the second PSE device has a second PSE device receiver to receive the first power consumption from the first PSE device; the second PSE device circuit is to: calculate the total power consumption from the first and second power consumptions; compare the total power consumption to the predetermined power consumption threshold; and disconnect a port of the second PSE device according to the first port disconnect list when the total power consumption is greater than the predetermined power consumption threshold.

Aspects as in one of the two preceding paragraphs provide a system, comprising a power over ethernet (POE) host having a POE host transmitter to transmit the first port disconnect list and the predetermined power consumption threshold from the POE host to the first PSE device.

Aspects as in one of the three preceding paragraphs provide a system, comprising a power over ethernet (POE) host having a POE host transmitter to transmit the first port disconnect list and the predetermined power consumption threshold from the POE host to the first PSE device and the second PSE device.

Aspects as in one of the four preceding paragraphs provide a system, wherein the POE host transmitter is to periodically transmit with a period greater than one second.

Aspects as in one of the five preceding paragraphs provide a system, wherein the second PSE device transmitter is to transmit from the second PSE device to the first PSE device in real time.

Aspects as in one of the six preceding paragraphs provide a system, wherein the predetermined power consumption threshold comprises a power consumption budget and a predetermined percentage.

Aspects as in one of the seven preceding paragraphs provide a system, wherein the first PSE device circuit is to: disconnect a port of the first PSE device according to a second port disconnect list when the total power consumption is greater than the predetermined power consumption threshold.

Aspects as in one of the eight preceding paragraphs provide a system, wherein the first PSE device circuit is to repeatedly within twenty milliseconds: measure by a first PSE device a first power consumption of the first PSE device; calculate by the first PSE device a total power consumption from the first and second power consumptions; and compare by the first PSE device the total power consumption to a power consumption budget and disconnecting a port of the first PSE device according to a first port disconnect list when the total power consumption is greater than a predetermined power consumption threshold; the second PSE device circuit is to repeatedly within twenty milliseconds: measure by the second PSE device a second power consumption of the second PSE device; and transmit the second power consumption from the second PSE device to the first PSE device.

According to aspects, there is provided a system comprising: a first power sourcing equipment (PSE) device; a second PSE device; a device bus connecting the first and second PSE devices to transmit with a period less than twenty milliseconds; a power over ethernet (POE) host; and a management bus connecting the POE host to the first and second PSE devices to transmit with a period greater than one second.

Aspects as in the preceding paragraph provide a system, wherein: the first PSE device has a first PSE device circuit to measure a first power consumption of the first PSE device and a first PSE device receiver to receive a second power consumption; the second PSE device has a second PSE device circuit to measure the second power consumption, wherein the second power consumption is of the second PSE device, and a second PSE device transmitter to transmit the second power consumption to the first PSE device; the first PSE device circuit is to: calculate a total power consumption from the first and second power consumptions; compare the total power consumption to a predetermined power consumption threshold; and disconnect a port of the first PSE device according to a first port disconnect list when the total power consumption is greater than the predetermined power consumption threshold.

### BRIEF DESCRIPTION OF THE FIGURES

A more complete understanding of the disclosure and the advantages thereof may be acquired by referring to the following description, taken in conjunction with the accompanying drawings and wherein:

FIG. 1 shows a block diagram of a POE system for power consumption budget management.

FIG. 2 illustrates a block diagram of a POE system for managing power sourced by power sourcing equipment (PSE) devices to power devices.

FIG. 3 illustrates a block diagram of a multi-port PSE device, as shown in FIG. 2.

FIG. 4 illustrates a flow chart of a method for a device circuit of a PSE device.

FIG. 5 illustrates a flow chart for a method for a manager circuit of a POE system.

FIG. 6 shows a flow chart of a method for managing power in a POE system.

FIG. 7 is a block diagram of circuitry 700 that, in some aspects, may be used to implement various functions, operations, acts, processes, and/or methods disclosed herein.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. It should be noted that the features illustrated in the drawings are not necessarily drawn to scale.

### DETAILED DESCRIPTION

In some applications, a PSE device is a multi-port network device supplying power to a number of Powered Devices (PDs). In that case, the total power demanded by the PDs is usually monitored to ensure the demand does not exceed the available power. The PSE device is typically formed as part of a managed power system where the managed power system acts to ensure that as new or increased loads are brought online, the total power demanded will not exceed the available power. The managed power system can be implemented using a central host controller and a digital communication bus or management bus where information about the new loads is factored into the total power consumption budget and decisions are made whether to power the new load or not. Alternately, the managed power system can include multiple controllers for each port of the PSE device where the controller for each port performs the power comparison and controls the activation of the associated port.

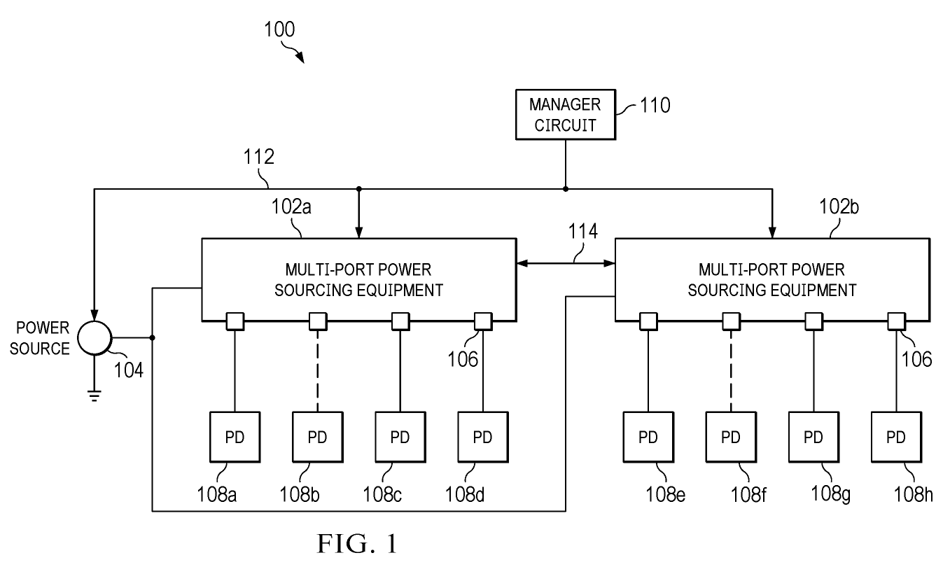

FIG. 1 shows a block diagram of a POE system 100 for power consumption budget management. Referring to FIG. 1, the POE system 100 includes a first multi-port Power Sourcing Equipment (PSE) device 102a and a second multi-port PSE device 102b. Both the first and second multi-port PSE devices 102a and 102b are coupled to a power source 104 providing a source of supply power. The power source 104 can be an AC power source or a DC power source. In the case of an AC power source, an AC-to-DC converter may be included in both the first and second multi-port PSE devices 102a and 102b to convert the AC power to DC power for distribution to the power ports. Both the first and second multi-port PSE devices 102a and 102b include multiple POE ports 106 for providing power to one or more Powered Devices (PDs) 108. In the present illustration, both the first and second multi-port PSE devices 102a and 102b include four POE ports 106 for supporting up to four PDs 108, respectively. In this description, a POE port 106 of a PSE 102 refers to a port of the PSE that supplies at least power to a network device connected thereto. The power may be provided on a twisted wire pair of an Ethernet cable separate from the twisted wire pair carrying the data signals or on the same twisted wire pair that also carry the data signals.

As individual powered devices 108 are connected to a PSE 102, or as individual powered devices 108 connected to a PSE 102 demands power from the PSE 102, the first and second multi-port PSE devices 102a and 102b supply a total dynamic power consumption from the power source 104. For instance, assuming that the first multi-port PSE device 102a is connected to and providing power for powered devices 108a, 108c and 108d, then the first multi-port PSE device 102a would be supplying a first dynamic power consumption. When powered device 108b is added to draw additional power from the first multi-port PSE device 102a, then the first multi-port PSE device 102a would be supplying a second dynamic power consumption, which would be higher than the first dynamic power consumption.

A manager circuit 110 is in data communication with the first and second multi-port PSE devices 102a and 102b and the power source 104 via a management bus 112. The manager circuit 110 transmits a port disconnect list and a power consumption budget to the first and second multi-port PSE devices 102a and 102b. The first multi-port PSE device 102a measures the dynamic power consumption of the first multi-port PSE device 102a when certain powered devices are drawing power from it, for example, powered devices 108a, 108c and 108d. Similarly, the second multi-port PSE device 102b measures the dynamic power consumption of the second multi-port PSE device 102b when certain powered devices are drawing power from it, for example, powered devices 108f and 108h. The first and second multi-port PSE devices 102a and 102b transmit their respective dynamic power consumptions to the other over a device bus 114. Both the first and second multi-port PSE devices 102a and 102b calculate a total power consumption for the POE system 100 by adding their respective dynamic power consumptions. Because they both have the same dynamic power consumption data, they both calculate the same total power consumption. Both the first and second multi-port PSE devices 102a and 102b compare by the first POE device the total power consumption to the power consumption budget and disconnect ports 106 according to the port disconnect list when the total power consumption is greater than a predetermined percentage of the power consumption budget.

In accordance with the power budget management scheme, a multi-port PSE device 102 may incorporate a power budget monitoring circuit to monitor the total power demand or consumption from all the POE ports 106 of the multi-port PSE device 102. A power consumption budget monitoring circuit may generate an output signal denoted OverBudget to indicate if the power demand exceeds an allowable power consumption budget. The power budget monitoring circuit may make a power availability determination based on the classifications of powered devices 108 consuming power. Under the IEEE standard 802.3-2005, Clause 33, powered devices 108 are divided in classes based on their specified power consumption. Therefore, based on the classification of the powered devices 108 connected to the POE ports 106, a total power demand can be computed. Alternatively, a total power consumption can be estimated based on the instantaneous power supplied to the power ports. Further, a total power consumption can also be measured directly by a multi-port PSE device 102.

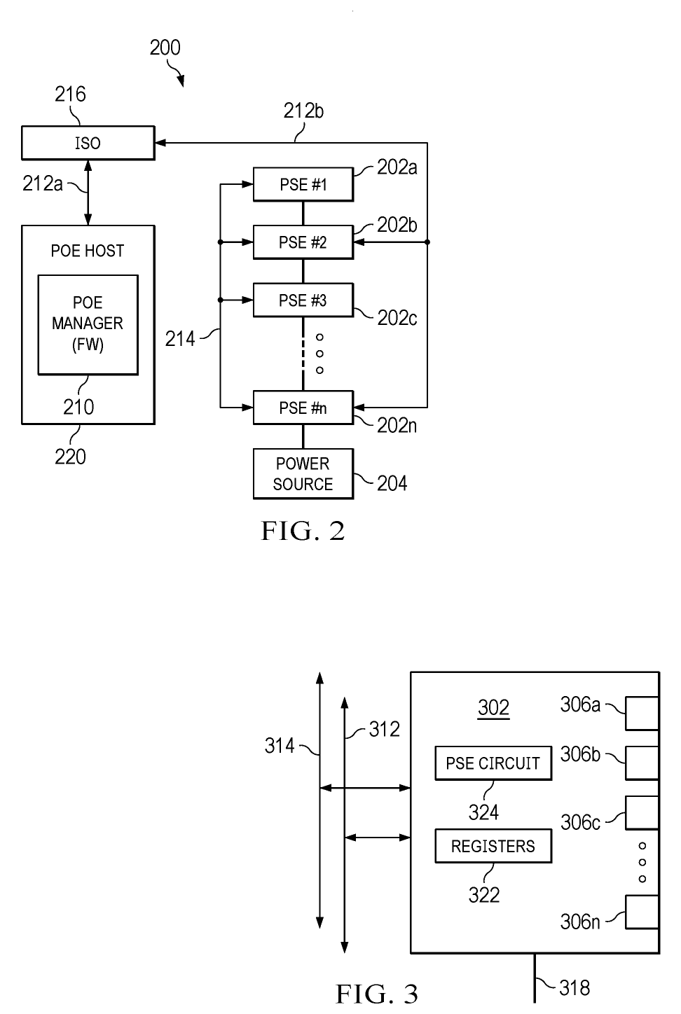

FIG. 2 illustrates a block diagram of a POE system 200 for managing POE. The POE system 200 includes a POE host 220, any number of multi-port PSE devices 202, a power source 204 supplying power to the multi-port PSE devices 202 via a power line 218, a management bus 212 data connecting the POE host 220 to the multi-port PSE devices 202 and the power source 204, and a device bus 214 data connecting the multi-port PSE devices 202. A power isolator 216 may be connected in the management bus 212. The POE host 220 may include a microcontroller having a processor, RAM, and a non-transitory computer readable medium for storing programs. The POE host 220 may include a POE manager circuit 210 stored in a non-transitory computer readable medium such as flash memory. The POE manager circuit 210 may be a non-real-time POE manager, which means it does not transmit instruction data in real-time, but rather transmits instruction data periodically. The POE manager circuit 210 may monitor the multi-port PSE devices 202a – 202n and power source 204 on a non-real-time basis via non-real time management bus 212. Non-real-time management bus 212 may be, for example, an I2C bus, and may be formed of two segments, 212a and 212b, isolated electrically by power isolator 216. The POE system 200 may include multiple multi-port PSE devices 202a – 202n, wherein respective ones are connected to real-time device bus 214, power source 204, and non-real-time management bus 212.

In this disclosure, “non-real-time” means periodically transmitting with a period greater than one second, and “real-time" means transmitting with a period less than or equal to one second.

FIG. 3 illustrates a block diagram of a multi-port PSE device 302, as shown in FIG. 2. A management bus 312 connects the POE host to the multi-port PSE device 302, and a device bus 314 connects the multi-port PSE device 302 to other PSE devices. The PSE device 302 receives power via power line 318. The multi-port PSE devices 302 may include POE ports 306a – 306n, registers 322, and a device circuit 324. One of registers 322 may represent configuration settings and may include a configurable mode with a value indicating a power advertisement mode. One of registers 322 may store the actual POE device power consumption as a percentage of the system power consumption budget. One of registers 322 may represent a disconnect table with individual bits corresponding to one of POE ports 306a – 306n, respectively. A set bit may designate the corresponding POE port 306 as one that may be disconnected in the event of excess power consumption. In some examples, another of registers 322 may represent a second level disconnect table with individual bits corresponding to one of POE ports 306a – 306n, respectively. A set bit designates the corresponding POE port 306a – 306n as one that may be disconnected in the event of a different scenario. For example, a different scenario might be excess power consumption that is not resolved after the ports designated in the first level disconnect table have been disconnected. One of registers 322 may store the total advertised power consumption for the entire system. One of registers 322 may store the system power consumption budget, for example in 0.1W increments.

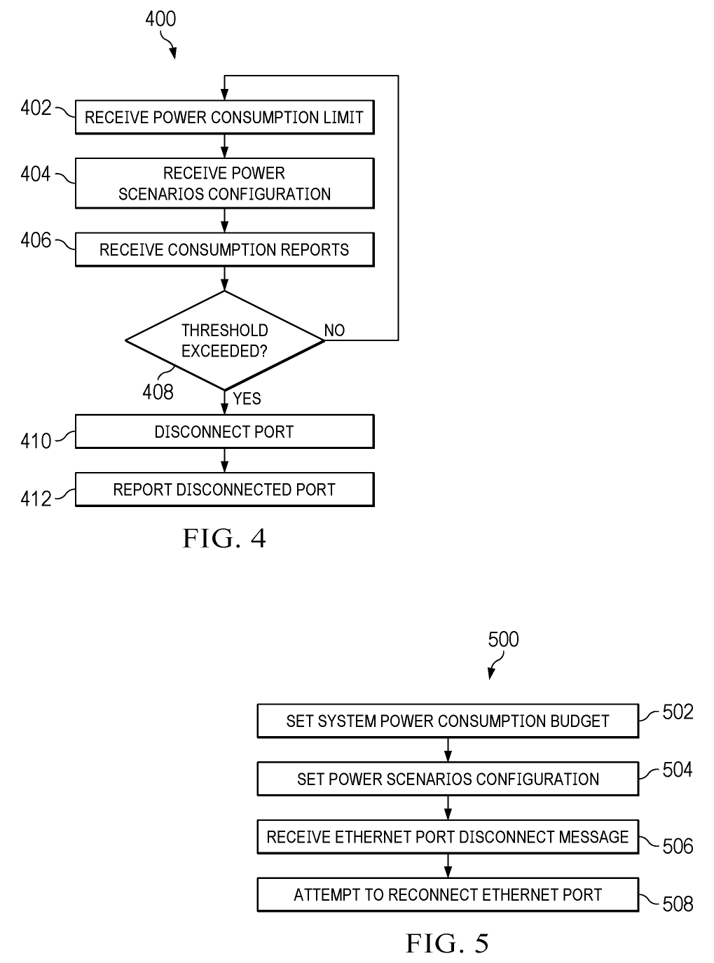

FIG. 4 illustrates a flow chart of a method for a device circuit of a PSE device. The method begins at block 402 with receipt by a PSE device of a power consumption limit. In some examples, the power consumption limit may be expressed as a total power consumption budget expressed in 0.1W and a threshold such as 105% of that total power consumption budget. In some examples, the threshold may be expressed in watts. At block 404, the PSE device may receive power scenarios configuration. For example, the PSE device may receive a one-byte value associated with a first power scenario with individual bits corresponding to an ethernet port, respectively. In another example, the PSE device may receive additional one-byte value associated with another power scenario. At block 406, the PSE device may receive consumption reports from other PSE devices. In some aspects, all of the individual PSE devices receive consumption reports from all other PSE devices. In other aspects, a subset of PSE devices receive consumptions reports from other PSE devices of the subset. In some aspects, the current consumption value may be represented in seven bits of information. As individual consumption reports are received within a window of time, the reported consumptions are tallied along with the current consumption of the receiving PSE device to calculate a total current consumption for the entire POE system. At block 408, the PSE device determines whether the total current consumption for the entire POE system exceeds the threshold. If NO, the flow returns to block 402. If YES, the flow proceeds to block 410, where the PSE device disconnects an ethernet port identified in the one-byte value associated with the first power scenario. At block 412, the PSE device reports the disconnected ethernet port to the POE manager via a non-real-time management bus.

FIG. 5 illustrates a flow chart for a method for a manager circuit of a POE system. The method begins at block 502 and the manager circuit sets the system power consumption budget, which may be a total power consumption in watts and a threshold percentage. At block 504, the manager circuit communicates with PSE devices over a non-real-time management bus to set the power scenarios configuration and relay the power consumption and threshold values. At block 506, the manager circuit receives (over non-real-time management bus) a POE port disconnect message from one of the PSE devices. At block 508, the POE manager attempts to reconnect the disconnected POE port by sending a control message over non-real-time management bus to the PSE device that sent the port disconnect message.

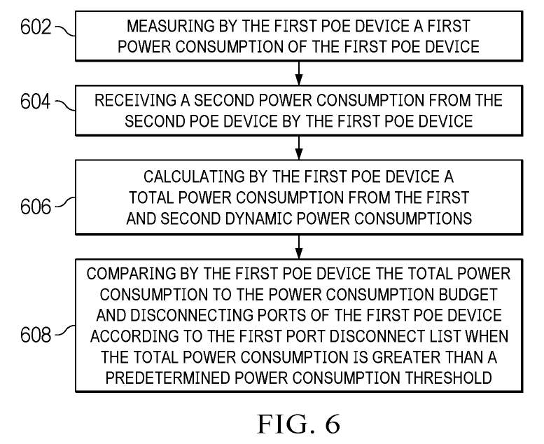

FIG. 6 shows a flow chart of a method for managing power in a POE system. The first POE device measures 602 a first power consumption of the first POE device. The first POE device receives 604 a second power consumption from a second POE device. The first POE device calculates 606 a total power consumption from the first and second power consumptions. The first POE device compares 608 the total power consumption to the power consumption budget and disconnects POE ports of the first POE device according to the first port disconnect list when the total power consumption is greater than a predetermined power consumption threshold.

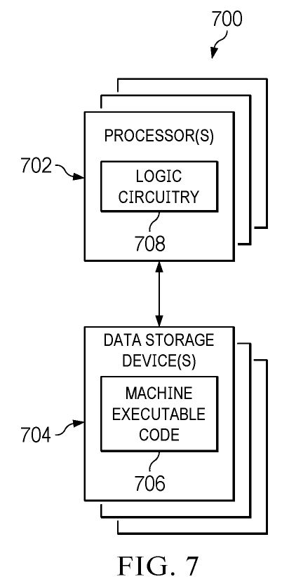

FIG. 7 is a block diagram of circuitry 700 that, in some aspects, may be used to implement various functions, operations, acts, processes, and/or methods disclosed herein. The circuitry 700 includes one or more processors 702 (sometimes referred to herein as “processors 702”) operably coupled to one or more data storage devices (sometimes referred to herein as “storage 704”). The storage 704 includes machine executable code 706 stored thereon and the processors 702 include logic circuitry 708. The machine executable code 706 includes information describing functional elements that may be implemented by (e.g., performed by) the logic circuitry 708. The logic circuitry 708 is adapted to implement (e.g., perform) the functional elements described by the machine executable code 706. The circuitry 700, when executing the functional elements described by the machine executable code 706, may be considered as specific purpose hardware configured for carrying out functional elements disclosed herein. In some aspects the processors 702 may perform the functional elements described by the machine executable code 706 sequentially, concurrently (e.g., on one or more different hardware platforms), or in one or more parallel process streams.

When implemented by logic circuitry 708 of the processors 702, the machine executable code 706 adapts the processors 702 to perform operations of aspects disclosed herein. For example, the machine executable code 706 may adapt the processors 702 to perform at least a portion or a totality of the power sourcing method 400 of FIG. 4, and/or the power management method 500 of FIG. 5. As another example, the machine executable code 706 may adapt the processors 702 to perform at least a portion or a totality of the operations discussed for the system 200 of FIG. 2. As a further example, the machine executable code 706 may adapt the processors 702 to perform at least a portion or a totality of the operations discussed for the PSE device 300 of FIG. 3. As a specific, non-limiting example, the machine executable code 706 may adapt the processors 702 to perform at least a portion of the object detection operations discussed herein.

The processors 702 may include a general purpose processor, a specific purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a specific-purpose computer while the general-purpose computer is configured to execute functional elements corresponding to the machine executable code 706 (e.g., software code, firmware code, hardware descriptions) related to aspects of the present disclosure. It is noted that a general-purpose processor (may also be referred to herein as a host processor or simply a host) may be a microprocessor, but in the alternative, the processors 702 may include any conventional processor, controller, microcontroller, or state machine. The processors 702 may also be implemented as a combination of computing devices, such as a combination of a DSP and a microprocessor, a plurality of microprocessors, one or more microprocessors in conjunction with a DSP core, or any other such configuration.

In some aspects the storage 704 includes volatile data storage (e.g., random-access memory (RAM)), non-volatile data storage (e.g., Flash memory, a hard disc drive, a solid state drive, erasable programmable read-only memory (EPROM), without limitation). In some aspects the processors 702 and the storage 704 may be implemented into a single device (e.g., a semiconductor device product, a system on chip (SOC), without limitation). In some aspects the processors 702 and the storage 704 may be implemented into separate devices.

In some aspects the machine executable code 706 may include computer-readable instructions (e.g., software code, firmware code). By way of non-limiting example, the computer-readable instructions may be stored by the storage 704, accessed directly by the processors 702, and executed by the processors 702 using at least the logic circuitry 708. Also by way of non-limiting example, the computer-readable instructions may be stored on the storage 704, transferred to a memory device (not shown) for execution, and executed by the processors 702 using at least the logic circuitry 708. Accordingly, in some aspects the logic circuitry 708 includes electrically configurable logic circuitry 708.

In some aspects the machine executable code 706 may describe hardware (e.g., circuitry) to be implemented in the logic circuitry 708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some aspects, the machine executable code 706 may include an HDL, an RTL, a GL description, a mask level description, other hardware description, or any combination thereof.

In aspects where the machine executable code 706 includes a hardware description (at any level of abstraction), a system (not shown, but including the storage 704) may be configured to implement the hardware description described by the machine executable code 706. By way of non-limiting example, the processors 702 may include a programmable logic device (e.g., an FPGA or a PLC) and the logic circuitry 708 may be electrically controlled to implement circuitry corresponding to the hardware description into the logic circuitry 708. Also, by way of non-limiting example, the logic circuitry 708 may include hard-wired logic manufactured by a manufacturing system (not shown, but including the storage 704) according to the hardware description of the machine executable code 706.

Regardless of whether the machine executable code 706 includes computer-readable instructions or a hardware description, the logic circuitry 708 is adapted to perform the functional elements described by the machine executable code 706 when implementing the functional elements of the machine executable code 706. It is noted that although a hardware description may not directly describe functional elements, a hardware description indirectly describes functional elements that the hardware elements described by the hardware description are capable of performing.

Although examples have been described above, other variations and examples may be made from this disclosure without departing from the spirit and scope of these examples.

What is claimed is:

1. A method comprising:
measuring by a first power sourcing equipment (PSE) device a first power consumption of the first PSE device;
receiving a second power consumption from a second PSE device by the first PSE device;
calculating by the first PSE device a total power consumption from the first and second power consumptions; and
comparing by the first PSE device the total power consumption to a power consumption budget and disconnecting a port of the first PSE device according to a first port disconnect list when the total power consumption is greater than a predetermined power consumption threshold.

2. The method as in claim 1, comprising:
transmitting the first power consumption from the first PSE device to the second PSE device;
calculating by the second PSE device the total power consumption from the first and second power consumptions; and
comparing by the second PSE device the total power consumption to the power consumption budget and disconnecting a port of the second PSE device according to the first port disconnect list when the total power consumption is greater than the predetermined power consumption threshold.

3. The method as in claim 1, comprising transmitting the first port disconnect list and the predetermined power consumption threshold from a power over ethernet (POE) host to the first PSE device.

4. The method as in claim 2, comprising:
transmitting the first port disconnect list and the predetermined power consumption threshold from a power over ethernet (POE) host to the first PSE device; and
transmitting the first port disconnect list and the predetermined power consumption threshold from the POE host to the second PSE device.

5. The method as in claim 3, wherein transmitting from the POE host to the first PSE device comprises periodically transmitting with a period greater than one second.

6. The method as in claim 1, wherein transmitting from the second PSE device to the first PSE device comprises transmitting in real time.

7. The method as in claim 1, wherein the predetermined power consumption threshold comprises a power consumption budget and a predetermined percentage.

8. The method as in claim 1, comprising disconnecting a port of the first PSE device according to a second port disconnect list when the total power consumption is greater than the predetermined power consumption threshold.

9. The method as in claim 1, comprising repeating within twenty milliseconds:
the measuring by a first PSE device a first power consumption of the first PSE device;
the measuring by a second PSE device a second power consumption of the second PSE device;
the transmitting the second power consumption from the second PSE device to the first PSE device;
the calculating by the first PSE device a total power consumption from the first and second power consumptions; and
the comparing by the first PSE device the total power consumption to a power consumption budget and disconnecting a port of the first PSE device according to a first port disconnect list when the total power consumption is greater than a predetermined power consumption threshold.

10. A system comprising:
a first power sourcing equipment (PSE) device having a first PSE device circuit to measure a first power consumption of the first PSE device and a first PSE device receiver to receive a second power consumption from a second PSE device;
wherein the first PSE device circuit is to:
calculate a total power consumption from the first and second power consumptions;
compare the total power consumption to a predetermined power consumption threshold; and
disconnect a port of the first PSE device according to a first port disconnect list when the total power consumption is greater than the predetermined power consumption threshold.

11. The system as in claim 10, wherein:
the first PSE device has a first PSE device transmitter to transmit the first power consumption to the second PSE device;
the second PSE device has a second PSE device receiver to receive the first power consumption from the first PSE device;
the second PSE device circuit is to:
calculate the total power consumption from the first and second power consumptions;
compare the total power consumption to the predetermined power consumption threshold; and
disconnect a port of the second PSE device according to the first port disconnect list when the total power consumption is greater than the predetermined power consumption threshold.

12. The system as in claim 10, comprising a power over ethernet (POE) host having a POE host transmitter to transmit the first port disconnect list and the predetermined power consumption threshold from the POE host to the first PSE device.

13. The system as in claim 11, comprising a power over ethernet (POE) host having a POE host transmitter to transmit the first port disconnect list and the predetermined power consumption threshold from the POE host to the first PSE device and the second PSE device.

14. The system as in claim 12, wherein the POE host transmitter is to periodically transmit with a period greater than one second.

15. The system as in claim 10, wherein the second PSE device transmitter is to transmit from the second PSE device to the first PSE device in real time.

16. The system as in claim 10, wherein the predetermined power consumption threshold comprises a power consumption budget and a predetermined percentage.

17. The system as in claim 10, wherein the first PSE device circuit is to:
disconnect a port of the first PSE device according to a second port disconnect list when the total power consumption is greater than the predetermined power consumption threshold.

18. The system as in claim 10, wherein the first PSE device circuit is to repeatedly within twenty milliseconds:
measure by a first PSE device a first power consumption of the first PSE device;
calculate by the first PSE device a total power consumption from the first and second power consumptions; and
compare by the first PSE device the total power consumption to a power consumption budget and disconnecting a port of the first PSE device according to a first port disconnect list when the total power consumption is greater than a predetermined power consumption threshold;
the second PSE device circuit is to repeatedly within twenty milliseconds:
measure by the second PSE device a second power consumption of the second PSE device; and
transmit the second power consumption from the second PSE device to the first PSE device.

19. A system comprising:
a first power sourcing equipment (PSE) device;
a second PSE device;
a device bus connecting the first and second PSE devices to transmit with a period less than twenty milliseconds;
a power over ethernet (POE) host; and
a management bus connecting the POE host to the first and second PSE devices to transmit with a period greater than one second.

20. The system as in claim 19, wherein:
the first PSE device has a first PSE device circuit to measure a first power consumption of the first PSE device and a first PSE device receiver to receive a second power consumption;
the second PSE device has a second PSE device circuit to measure the second power consumption, wherein the second power consumption is of the second PSE device, and a second PSE device transmitter to transmit the second power consumption to the first PSE device;
the first PSE device circuit is to:
calculate a total power consumption from the first and second power consumptions;
compare the total power consumption to a predetermined power consumption threshold; and
disconnect a port of the first PSE device according to a first port disconnect list when the total power consumption is greater than the predetermined power consumption threshold.
